(19) United States
(12) Patent Application Publication
(10) Pub. No.: US 2022/0355530 A1
(43) Pub. Date: Nov. 10, 2022

(54) NON-CONTINUOUS ROTATION BACKWASHING FILTER APPARATUS FOR RUBBER/PLASTIC EXTRUSION/INJECTION MACHINE

(71) Applicant: YIH SIN LIU, Taichung City (TW)

(72) Inventor: YIH SIN LIU, Taichung City (TW)

(21) Appl. No.: 17/308,880

(22) Filed: May 5, 2021

(51) Int. Cl. B29C 48/694; B29C 45/24

(52) U.S. Cl. CPC B29C 48/694; B29C 45/24

(57) ABSTRACT

A non-continuous rotation backwashing filter apparatus for a rubber/plastic extrusion/injection machine includes a machine frame having a rail, a rotary filter screen piston seat mounted to the rail and configured to carry a rotary filter screen piston covered with at least one layer of filter screen, and a die head. The rotary filter screen piston is telescopically pushed into a flow channel of the die head. The die head includes a flow channel pressure detector. In a normal state, the rotary filter screen piston does not rotate. When the flow channel pressure detector detects that the pressure of the flow channel rises to a predetermined value, the rotary filter screen piston begins to rotate for backwashing impurities on the filter screen. It can increase the filtering area of the filter screen, and the non-continuous rotation does not consume energy.

### FIELD OF THE INVENTION

The present invention relates to a rubber/plastic granulation extrusion/injection apparatus, and more particularly to a non-continuous rotation backwashing filter apparatus for a rubber/plastic extrusion/injection machine.

### BACKGROUND OF THE INVENTION

In the extrusion or injection process for rubber/plastic granulation, because the liquid raw material flow, including new materials or recycled materials, is mixed with impurities, the impurities need to be filtered out and removed. According to practical experience, in the conventional filtering operation, after a filter screen is used for a period of time, it is easy to be blocked by accumulated impurities and cause loss of pressure. It is necessary to halt the machine for replacing the filter screen before the filtering operation is continued, which will affect the production efficiency.

However, the filtering area of the conventional filter screen is small, and the filter screen is easily blocked. As a result, the filter screen needs to be replaced frequently. A continuous rotation filter screen structure able to increase the filtering area is developed on the market. However, it can be known from the actual operation that this continuous rotation filter screen structure is very energy-consuming because of the normal continuous driving operation, and it causes the problem that the raw material and the filter residue are mixed and difficult to filter. This is not an ideal solution.

### SUMMARY OF THE INVENTION

The primary object of the present invention is to provide a backwashing filter apparatus used for a filter screen of a rubber/plastic extrusion/injection machine, which can increase the filtering area of the filter screen and reduce the frequency of replacing the filter screen.

In order to achieve the foregoing object, a non-continuous rotation backwashing filter apparatus for a rubber/plastic extrusion/injection machine is provided. The non-continuous rotation backwashing filter apparatus comprises a machine frame, a rotary filter screen piston seat, and a die head. The machine frame includes at least one rail mounted thereon. The rotary filter screen piston seat is mounted to the rail of the machine frame. The rotary filter screen piston seat is configured to carry a rotary filter screen piston covered with at least one layer of filter screen. The rotary filter screen piston is telescopically pushed into a flow channel of the die head disposed on the machine frame. The die head includes a flow channel pressure detector. In a normal state, the rotary filter screen piston does not rotate. When the flow channel pressure detector in the die head detects that the pressure of the flow channel rises to a predetermined value, the rotary filter screen piston begins to rotate for backwashing impurities on the filter screen. When the pressure of the flow channel lowers to the predetermined value, the rotary filter screen piston stops rotating for performing the filtering operation. It can increase the filtering area of the filter screen, and the non-continuous rotation does not consume energy.

Furthermore, the machine frame is provided with a telescopic cylinder. The telescopic cylinder includes a telescopic arm. The telescopic arm is connected to the rotary filter screen piston seat. The rotary filter screen piston is telescopically pushed by the telescopic cylinder to get in and out of the flow channel of the die head, so that the operation of replacing the filter screen is simple and fast.

### BRIEF DESCRIPTION OF THE DRAWINGS

FIG. 1 is a perspective view according to an embodiment of the present invention;

FIG. 2 is a first planar view according to an embodiment of the present invention; and

FIG. 3 is a second planar view according to an embodiment of the present invention.

### DESCRIPTION OF THE PREFERRED EMBODIMENTS

Embodiments of the present invention will now be described, by way of example only, with reference to the accompanying drawings.

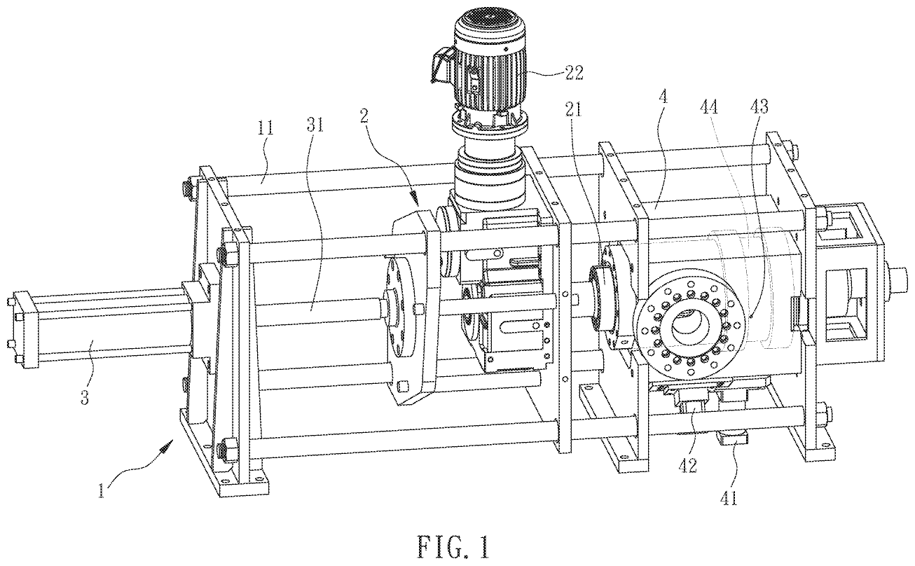

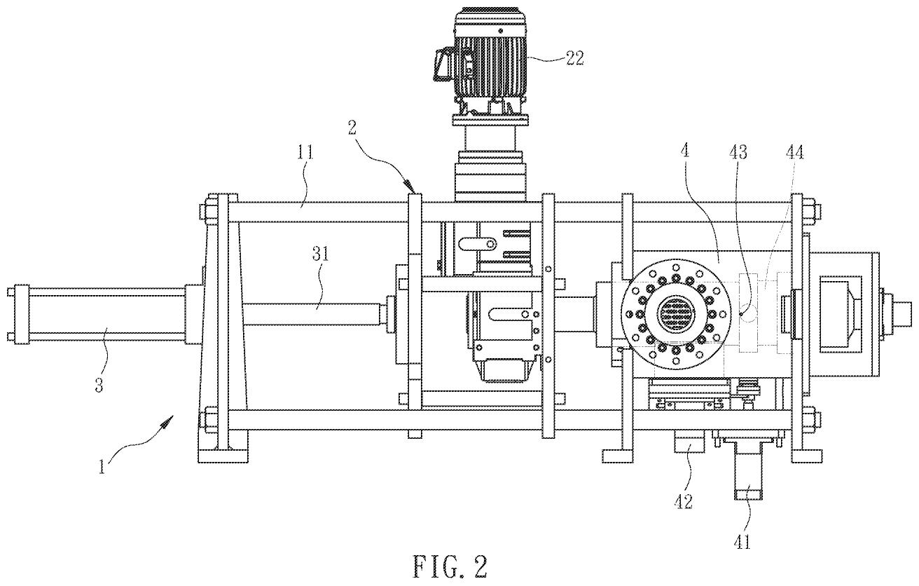

As shown in FIG. 1 and FIG. 2, a non-continuous rotation backwashing filter apparatus for a rubber/plastic extrusion/injection machine according to an embodiment of the present invention comprises a machine frame 1, a rotary filter screen piston seat 2, a telescopic cylinder 3, and a die head 4.

The machine frame 1 includes at least one rail 11 mounted thereon.

The rotary filter screen piston seat 2 is mounted to the rail 11 of the machine frame 1. The rotary filter screen piston seat 2 is configured to carry a rotary filter screen piston 21 covered with at least one layer of filter screen 211. The mesh size and the number of layers of the filter screen 211 are selectively arranged according to different materials to be filtered. The rotary filter screen piston 21 is driven to rotate by a rotary filter screen drive unit 22. The rotary filter screen drive unit 22 is a hydraulic motor. The rotary filter screen drive unit 22 is carried by the rotary filter screen piston seat 2.

The telescopic cylinder 3 is disposed on the machine frame 1. The telescopic cylinder 3 includes a telescopic arm 31. The telescopic arm 31 is connected to the rotary filter screen piston seat 2.

The die head 4 is disposed at one end of the machine frame 1. The die head 4 includes a pressure regulating valve 41 and a residue discharge valve 42. The die head 4 further includes a flow channel pressure detector 43.

The rotary filter screen piston 21 is telescopically pushed in the rotary filter screen piston seat 2 through the telescopic cylinder 3, so as to get in and out of the flow channel 44 of the die head 4.

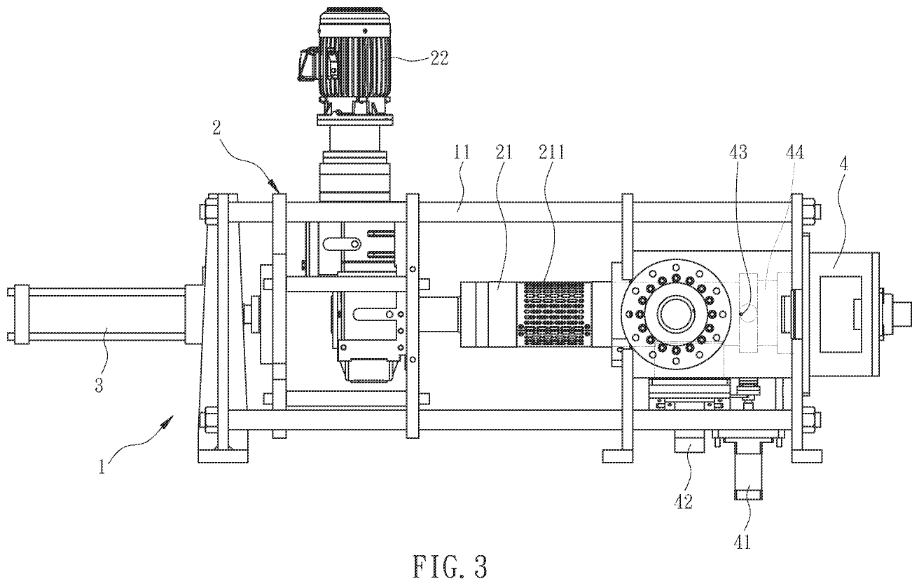

As shown FIG. 2 and FIG. 3, the rotary filter screen piston 21 is pushed by the telescopic cylinder 3 to communicate with the flow channel 44 of the die head 4 for filtering. At this time, the rotary filter screen piston 21 is not rotated.

The pressure regulating valve 41 of the die head 4 is opened to reduce pressure, while the residue discharge valve 42 is closed to prevent material leakage.

After filtering for a period of time, when the flow channel pressure detector 43 in the die head 4 detects that the filter screen 211 is blocked by the impurities, causing the pressure to rise to a predetermined value, the rotary filter screen piston 21 begins to rotate for backwashing impurities on the filter screen. At this time, the residue discharge valve 42 of the die head 4 is opened, and the pressure regulating valve 41 is closed to increase the pressure of the flow channel 44 in the die head 4, so that the filter residue is discharged from the residue discharge valve 42.

When the flow channel pressure detector 43 detects that the pressure of the flow channel 44 lowers to the predetermined value, the machine is reset to the normal operation of filtering the raw material, the rotary filter screen piston 21 stops rotating, the pressure regulating valve 41 of the die head 4 is opened again to reduce pressure, and the residue discharge valve 42 is closed to prevent material leakage.

Furthermore, when the filter screen 211 undergoes repeated filtration, backwashing, filtration and backwashing, the pressure in the flow channel 44 continues to be too high and the pressure cannot be reduced through the above steps, the telescopic cylinder 3 retracts the rotary filter screen piston 21 from the flow channel 44 of the die head 4 to perform the operation of replacing the filter screen. The operation of replacing the filter screen is simple and fast. There is no need to disassemble the machine for replacing the filter screen. At this time, the pressure regulating valve 41 of the die head 4 is opened to reduce pressure, and the residue discharge valve 42 is closed to prevent material leakage.

The advantages of this invention are as follows:

A. By rotating the filter screen, the filtering area of the filter screen is increased effectively, the frequency of replacing the filter screen is decreased, and the work efficiency is improved.

B. When the filter screen is blocked, it will automatically rotate and backwash, so as to reduce the frequency of replacing the filter screen.

C. The non-continuous rotation filtering is only rotated for backwashing, thereby reducing operating energy consumption.

D. With the multi-layer filter screen, the mesh size and the number of layers of the filter screen are selectively arranged according to different raw materials, so as to improve the filtering effect.

E. The rotary filter screen piston is moved into and out of the flow channel by the telescopic cylinder, which is convenient and quick to replace the filter screen.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A non-continuous rotation backwashing filter apparatus, comprising a machine frame, a rotary filter screen piston seat, and a die head;
the machine frame including at least one rail mounted thereon;
the rotary filter screen piston seat being mounted to the rail of the machine frame, the rotary filter screen piston seat being configured to carry a rotary filter screen piston covered with at least one layer of filter screen, the rotary filter screen piston being telescopically pushed into a flow channel of the die head disposed on the machine frame;
the die head including a flow channel pressure detector.

2. The non-continuous rotation backwashing filter apparatus as claimed in claim 1, wherein the machine frame is provided with a telescopic cylinder, the telescopic cylinder includes a telescopic arm, the telescopic arm is connected to the rotary filter screen piston seat, the rotary filter screen piston is telescopically pushed by the telescopic cylinder to get in and out of the flow channel of the die head.

3. The non-continuous rotation backwashing filter apparatus as claimed in claim 1, wherein the die head includes a pressure regulating valve and a residue discharge valve.

4. The non-continuous rotation backwashing filter apparatus as claimed in claim 1, wherein the rotary filter screen piston is driven to rotate by a rotary filter screen drive unit.

5. The non-continuous rotation backwashing filter apparatus as claimed in claim 4, wherein the rotary filter screen drive unit is a hydraulic motor.
